(19) United States
(12) Patent Application Publication
(10) Pub. No.: US 2001/0040130 A1
(43) Pub. Date: Nov. 15, 2001

(54) Detection of pyrogen and other impurities in water

(75) Inventors: Walter F. Lorch, Fulmer (GB); David C. Cullen, Cranfield (GB)

Correspondence Address: FLESHNER & KIM, LLP, P.O. Box 221200, Chantilly, VA, 20153-1200, US

(73) Assignee: Cranfield University

(21) Appl. No.: 09/768,300

(22) Filed: Jan. 25, 2001

Related U.S. Application Data
(63) Continuation of application No. PCT/GB99/02339, filed on Jul. 20, 1999.

(30) Foreign Application Priority Data
Jul. 28, 1998 (GB) 9816441.1

(51) Int. Cl. C02F 3/00

(52) U.S. Cl. 210/601; 210/85; 210/96.1; 210/263; 210/660; 210/745; 210/749; 210/94

(57) ABSTRACT

High purity water, particularly that intended for the pharmaceutical or electronics industry, is analyzed for the presence of pyrogen or other impurities by causing the water to come into contact with a direct affinity sensor, which may be a surface plasmon resonance (SPR) device or other sensor relying on an evanescent wave phenomenon. A property of the surface—refractive index in the case of SPR—changes on the binding of impurity, thereby enabling impurity to be detected. The invention overcomes the cumbersome nature and batch-to-batch variability of the conventional in vivo tests as well as the in vitro Limulus Amoebocyte Lysate (LAL) assay and for the first time allows the continuous or real time monitoring of high purity water for pyrogen.

THIS INVENTION relates to the analysis of liquids. In particular, it relates to the detection of impurities such as pyrogens in water. The invention therefore finds application in the preparation and testing of high purity water for medical, pharmaceutical and other uses, such as in the electronics industry.

From time immemorial water has been one of the most important and one of the most frequently used ingredients of pharmaceutical preparations. Its importance was increased enormously by the introduction of parenteral (injection and intravenous infusion) therapy and it was eventually realised that water for such therapy must be sterile (free from living micro-organisms) and apyrogenic (free from pyrogens), as well as being of high chemical purity (Whittet and D'Arcy, “Sterile and apyrogenic water” in “Handbook of Water Purification”, Lorch (Ed.), 2^{nd} Edition, 1987, Ellis Horwood, Chichester). The term “pyrogen” can broadly and functionally be defined as a substance which gives rise to fever on parenteral (for example intravenous) administration to humans or other mammals. Endotoxins are pyrogenic substances present in living bacteria: lysed bacteria liberate soluble pyrogenic endotoxins or fractions of them. Many endotoxins are lipopolysaccharides (LPSs), some of the most pyrogenic of which derive from gram-negative bacteria and may be the result of breakdown of the cell wall. Whatever their precise nature, pyrogenic impurities in water are a very important practical problem because, unless solutions used to inject or infuse medicaments are free from these impurities, patients receiving injections or infusions will suffer from fevers which will interfere with their recovery.

The usefulness of high purity water is not restricted to medical science. For example, in the electronics industry, so called ultra-pure water is used for cleaning purposes in the manufacture of printed circuits, semiconductors, transistors and integrated circuits. Quite early in the history of high volume production it was realised that the proper function and long-term stability of electronic devices could be improved by intensive cleansing (decontamination) of the active crystal surfaces (Lorch, “Electronics industry” in “Handbook of Water Purification”, loc. cit.). Pyrogens are usually the last non-volatile impurity to be removed in water purification processes other than distillation so that pyrogen-free, highly purified water gives the very low residue water required in the production of electronic components. As these components become smaller, there is a need for higher purity. Paradoxically, it is not currently usual for the electronics industry to test water for pyrogens, both because of the vast quantities of high purity water used and because of the time that would be involved in meaningful testing.

The need for water which is free of pyrogens and other impurities implies a corresponding need for a method of assaying water to see whether it meets the relevant criteria. The British, European and United States Pharmacopoeias all refer to in vivo tests for determining pyrogenicity of water for injections (or equivalent), whereby a given volume of the water under test is injected into each of a group of rabbits; the water is deemed to be pyrogen-free, within the limits of the assay, if the total body temperature rise of the rabbits does not exceed a predetermined amount over a given period of time, typically three hours.

The cumbersome nature of such an assay is self-evident and prompted the development of an in vitro test in the early 1970s: this is the Limulus Amoebocyte Lysate, or LAL, test. The LAL test is based on the observation, made in the 1950s, that gram-negative infections of the horseshoe crab Limulus polyphemus produced fatal intravascular coagulation, due to the action of endotoxin (a pyrogen) upon clottable protein contained in the amoebocytes, the only circulating blood cells of the crab. A cell lysate from washed amoebocytes was an extremely sensitive indicator of the presence of endotoxin and formed the basis of an endotoxin assay (Whittet and D'Arcy, loc. cit. and Levin et al., Ann. Int. Med. 1 76 (1971)). Unfortunately, the properties of the lysate vary between batches of material. While this problem has been addressed in the United States by producing a standard preparation of defined bacterial endotoxin, difficulties with the assay remain. One is that continued extraction of amoebocyte lysate from Limulus has an implication for the survival of the horseshoe crab itself. Another, and more fundamental, problem with both the LAL test and the rabbit pyrogen test described above is that they are either impractical or inherently incapable of being adapted for continuous, or even non-continuous but nevertheless real time, operation: each test can only be performed on a discrete sample from a volume of water, and this means that the vast majority of the water goes untested.

In the context of pyrogen or other impurities in high purity water, very low concentrations need to be detected or measured. This invention provides a new assay for impurities such as pyrogens in high purity water which does not suffer from the disadvantages of the assays discussed above.

According to a first aspect of the invention, there is provided a method for analysing high purity water for the presence of impurity, the method comprising causing water under analysis to come into contact with a surface having an affinity for a potential impurity in the water, and wherein the surface has a property which changes on binding of the impurity to the surface, and monitoring the surface for a change in the property.

Preferred embodiments of the invention will now be described. In the following description, including the specific examples, reference is made to the accompanying drawings, in which:

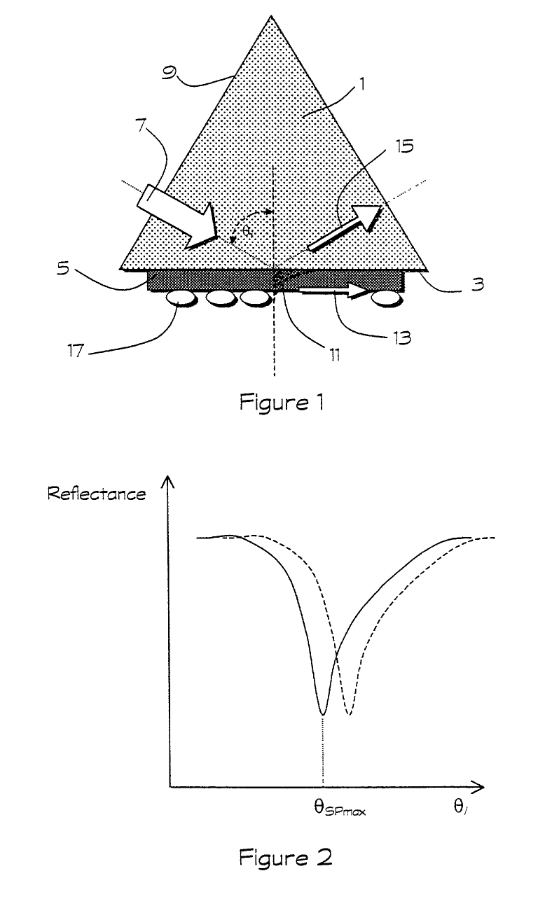

FIG. 1 schematically shows a Kretschmann configuration of a surface plasmon resonance device, which may be adapted for use in the present invention;

FIG. 2 is a graph illustrating how reflectance in a Kretschmann SPR module varies with incident angle;

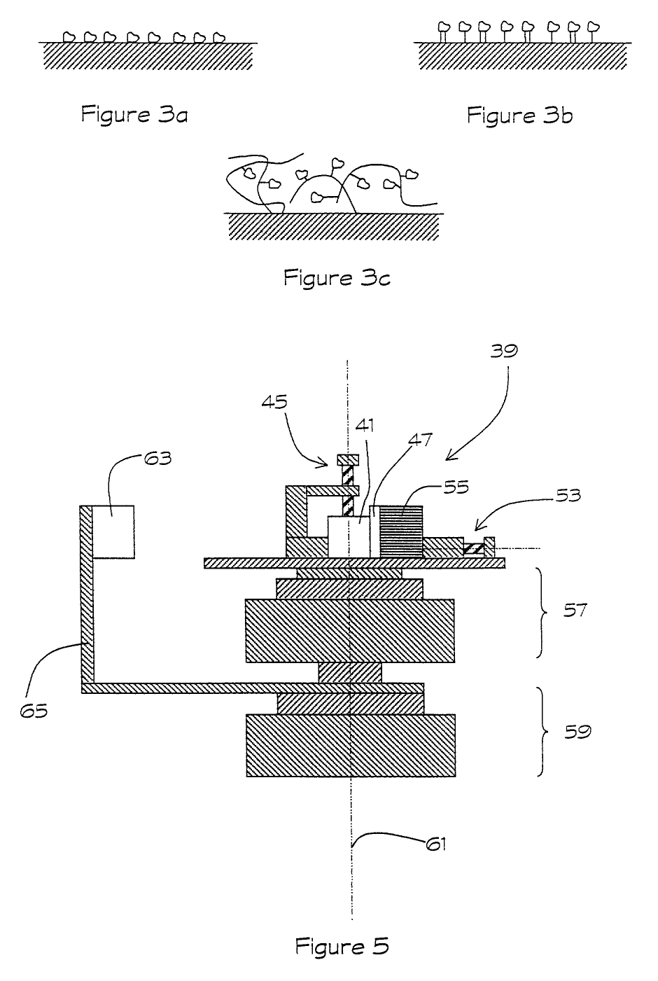

FIGS. 3a, 3b and 3c show three ways in which a specific binding molecule may be attached to a surface, namely (a) by direct physical adsorption, (b) by the use of a chemical cross-linker and (c) by the use of a polymer modified surface, respectively;

FIG. 4 shows schematically an apparatus which is a first embodiment of the invention and which is discussed in detail in Example 1;

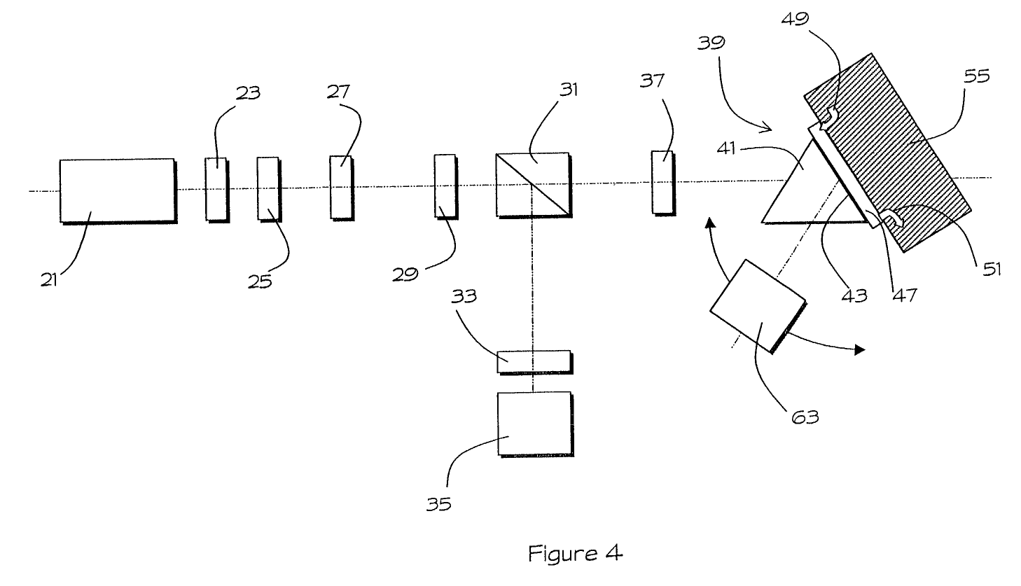

FIG. 5 shows a sectional view through a rotation stage assembly on which is mounted the surface plasmon resonance (SPR) device which forms part of the apparatus shown in FIG. 4;

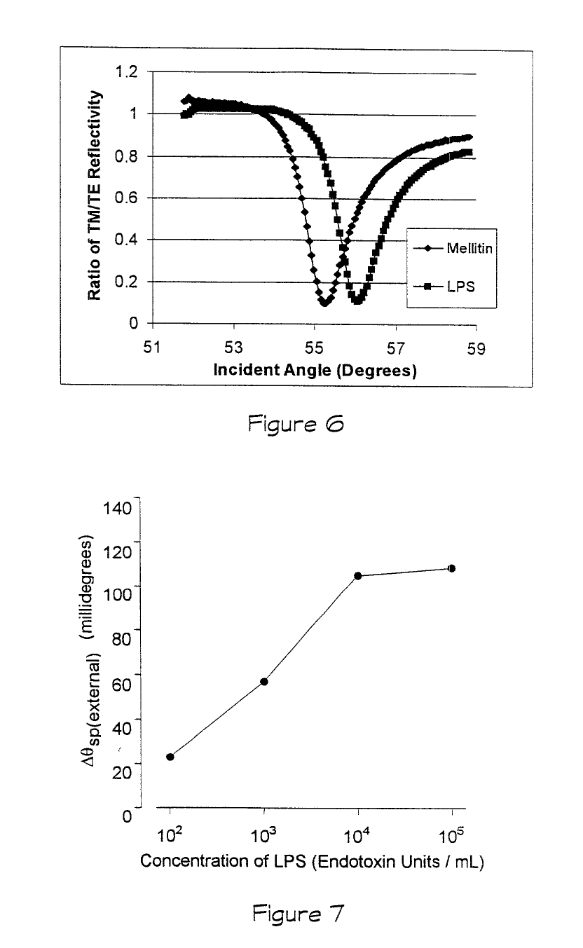

FIG. 6 shows a typical SPR response obtained with the apparatus shown in FIGS. 4 and 5;

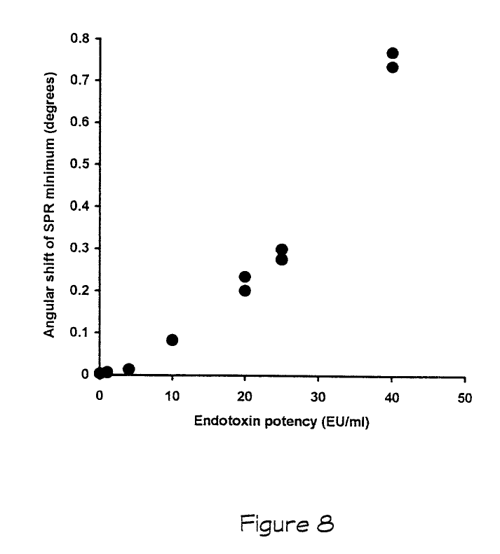

FIG. 7 summarises a series of SPR experiments conducted with the apparatus shown in FIGS. 4 and 5 where the concentration of lipopolysaccharide in high purity water was varied between 10⁵ and 10² endotoxin units per milliliter (EU/ml)

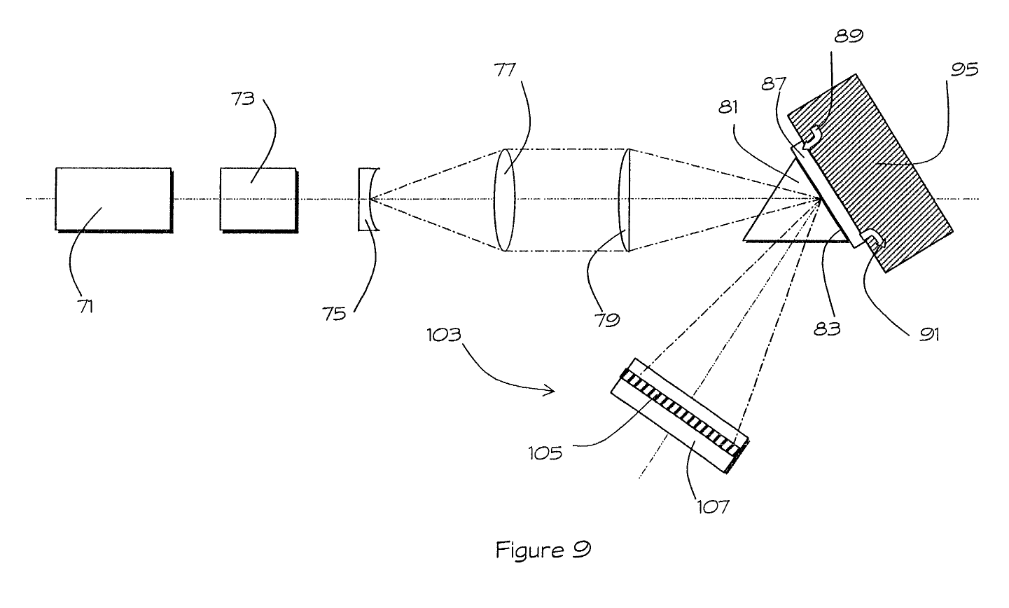

FIG. 8 summarises a series of SPR experiments conducted with the apparatus shown in FIGS. 4 and 5 where the concentration of endotoxin in high purity water was varied between 0 and 40 endotoxin units per milliliter (EU/ml) and using experimental protocols refined from those used to obtain the FIG. 7 data;

FIG. 9 shows schematically an apparatus which is a second embodiment of the invention and which is discussed in Example 2; and

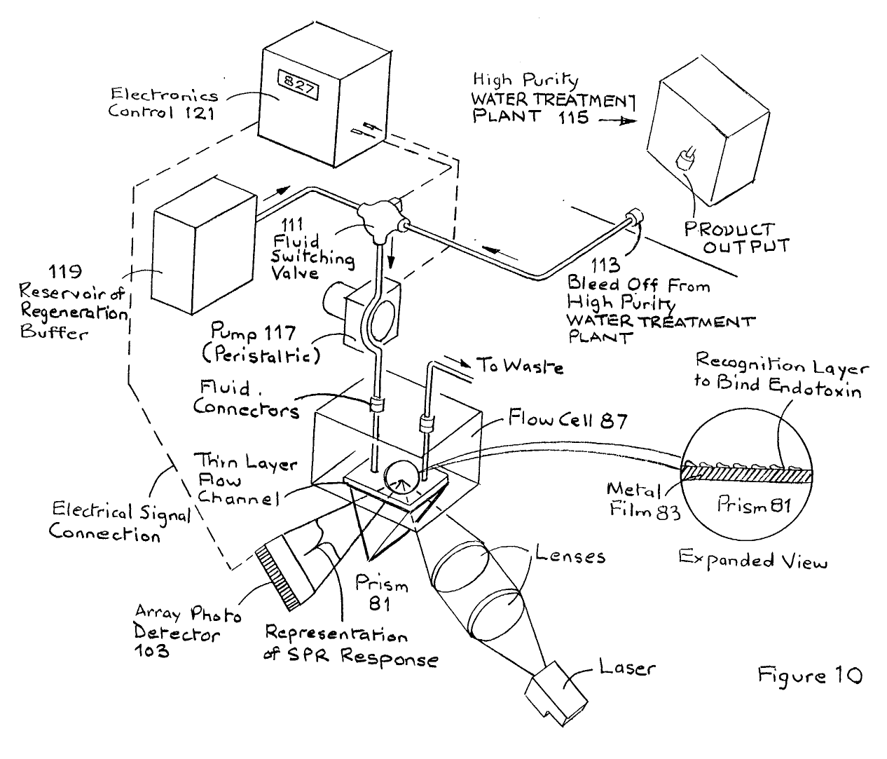

FIG. 10 shows schematically a high purity water system incorporating an apparatus of the invention as shown in FIG. 9 and as discussed in Example 2.

The invention is based, in part, on the concept of direct affinity sensing, and the surface referred to above may be regarded as constituting or forming part of a direct affinity sensor or transducer. Within analytical science, an analyte can be a single chemical/biochemical species or a range of chemical/biochemical species and/or mixtures of chemical/biochemical species typically being related, e.g. organic impurities in water. One common approach to determine the presence of, and to quantify the amount of, an analyte is to design a surface (which term is used to mean interfaces in general) that will interact with the analyte in a manner that enables the interaction to be measured and distinguished from interactions with other components of a sample and hence relate the magnitude or degree of interaction to the concentration of the analyte in the sample being analysed. A familiar example would be a pH electrode wherein a pH sensitive membrane interacts, in general, only with hydrogen ions in a sample producing a change in electrical potential that can be measured by a suitable electronic circuit. Direct affinity sensors are another example of this approach where a surface is adapted, for example by being modified with a suitable biological or chemical coating, to discriminate and interact by binding (for example physically) to a complementary analyte in a sample. (“Surface”, in this context, includes polymer-modified and other treated surfaces or interfaces.) Antibodies are a common example of biological coatings, relying on the organised array of physical interactions that occur within the antibody binding site to recognise and bind a complementary antigen or analyte with a high degree of specificity, i.e. bio-recognition; other molecules constituting specific binding pairs, such as avidin and biotin, are well known in biology and may equally have application in the present invention. For chemical coating, as well as some biological coatings, physical interactions may result in the binding of ranges of analytes that display common features rather than the generally high specificity of biological systems, such as ion-exchange coatings that will interact with complementarily charged analytes. The coating, whatever its nature, need not be homogeneous, and may comprise different entities for binding the same analyte and/or different entities for binding different analytes. The binding of the analyte to the biological or chemical coating changes a property of the surface, which typically constitutes the surface of a transducer which enables the binding to be measured or otherwise reported. The transducer can take many forms, with typical examples being: optical transducers that measure the change in the optical properties associated with the binding events; piezo-electric transducers that measure predominantly the change in mass associated with the binding events; and, less usually, electrochemical transducers that can measure electrical properties such as capacitance associated with the binding events. A shared feature of direct affinity sensors is for the transducer to be designed such that the transducer only interrogates a region in close proximity to the surface thereby having the majority of the measured signal contributed by the changes occurring in the chemical or biological coating on, or near, the surface of the transducer. Another common aspect of direct sensors is the lack of a requirement for additional reagents such as fluorescent, radioactive and enzyme labelled components to produce an analytical result thereby, in principle, simplifying the production and use of such analytical systems. (The use of a fluorescent-labelled indirect optical evanescent wave sensor for endotoxin has been reported: Detection of endotoxin using an evanescent-wave fiberoptic biosensor, James, E. A., Schmeltzer, K. & Ligler, F. S., Applied Biochemistry and Biotechnology 60 189-202 (1996)). In addition, this enables, with suitable transducers, measurements to be made in real-time (either continuously or on a quasi-continuous basis, for example where periodic recharging is appropriate) rather than the more usual batch or discrete measurements made by such approaches as many immunoassay formats and traditional analytical techniques such as chromatography.

In the practical implementation of direct affinity sensing in general, and in the practice of the present invention, optical transducers are frequently chosen as the preferred transducer for direct affinity sensors. The majority of optical transducers rely upon the generation of optical evanescent waves at the surface of suitable optical transducers. Examples include devices based upon surface plasmon resonance (SPR), the resonant mirror, grating couplers and waveguide interferometers. Optical evanescent waves are electromagnetic waves of optical frequency, including visible and infrared frequencies, that travel along a suitable interface and have a maximum intensity at the interface and that in at least one direction orthogonal to the interface, decay rapidly away from the interface such that the majority of the optical field is within a distance equivalent to a fraction of the wavelength of the optical radiation commonly used to generate the evanescent waves. As an example, optical evanescent waves exist in the typically low refractive index region surrounding the high refractive index region of a dielectric optical waveguide such as that found in the resonant mirror and grating coupler optical transducers. Evanescent waves therefore interact predominantly with the interfacial region and can be influenced by changes in the optical properties within this region.

Of optical transducers for use in direct affinity sensors, those based upon the optical excitation of surface plasmons, i.e. SPR devices, is often a preferred choice. (Reviews of the phenomenon of surface plasmon resonance include those by Raether, H., in “Physics of Thin Films”, Volume 9, 145-261, Academic Press, London, 1977, and Welford, K., “Surface plasmon-polaritons and their uses”, Optical and Quantum Electronics 23 1-27 (1991); a recent review of application of SPR to biotechnology is by Silin, V. & Plant, A., “Biotechnological applications of surface plasmon resonance”, Trends in Biotechnology 15 353-359 (1997).) Surface plasmons exist at the surface of a material whose electrons behave as a quasi-free electron gas, e.g. metals and semiconductors. Surface plasmons consist of oscillations of the surface charges produced by external electric fields. The oscillating charges are associated with evanescent, surface bound, electromagnetic waves that have a maximal intensity at the surface and decay rapidly away from the surface, typically within tens to hundreds of nanometers. SPR consists of the external stimulation of surface plasmons by applying an electric field typical varying in spatial and/or temporal dimensions such that, at given values, the spatial and temporal properties of the external electric field match those characteristic of surface plasmons at a given surface whereby resonance occurs and energy is transferred from the external electric field to create or excite the surface plasmons, hence SPR. Any changes of the properties of the surface and surface region, i.e. the interface, that is within the influence of the surface plasmon evanescent wave, such as its refractive index and/or roughness, i.e. refractive index distribution, will change the resonance conditions required to excite surface plasmons, i.e. the values of the spatial and temporal distributions of the exciting external electric field required to excite surface plasmons. Therefore, by monitoring and varying the properties of the exciting external electric field, SPR can be used to monitor and if desired measure any refractive index changes that may occur at suitable interfaces.

The practical implementation of direct affinity sensors can take a number of forms. For SPR, common implementations include metal-coated prisms, metal-coated gratings, metal-coated fibre optics. The most frequent format, the Kretschmann configuration, is illustrated schematically in FIG. 1. It generally consists of a prism 1, typically made of glass, with one face 3 coated with a thin film 5, in the range of tens of nanometers, of a metal. Usually gold is the preferred metal as this produces an acceptable practical compromise between a sharp SPR response, thus sensitivity for analytical applications, and chemically stability for many applications. Silver is an acceptable alternative metal, giving a sharper SPR response though with decreased chemical stability. An appropriate light beam 7, such as a collimated, monochromatic, transverse magnetic polarised light beam from a laser, is shone through a non-metal-coated face 9 of the prism so as to be totally internally reflected off the internal metal-coated face 3 of the prism. “Transverse magnetic” (TM) means that the magnetic field vector of a light beam is transverse to the plane of incident and reflection of the light beam incident upon an interface. The angle of incident (θₗ) of the light beam on this interface is varied and the intensity of the reflected beam measured as a function of the incident angle. Over most incident angles greater than the critical angle for total internal reflection, the majority of the light is reflected, generally greater than 90%, except when surface plasmons are excited. At certain incident angles, the spatial and temporal properties of the incident light, i.e. wavelength component parallel to the interface and frequency, match those of the surface plasmons, resulting in the resonant excitation of surface plasmons 13. The transfer of energy 11 from the light beam to excite the surface plasmons 13, which subsequently decay by processes including non-radiative processes, results in a reduced intensity of the reflected light beam 15 when surface plasmons are excited. This is measured and the incident angle corresponding to the minimum internal reflectance, and hence maximum surface plasmon excitation (θ_{SPmax}), determined. This angle changes as the refractive index of the material within the region of the evanescent wave associated with the surface plasmons changes. So, for analytical applications, changes in a suitable chemical or biological coating 17 caused by interaction, e.g. binding, with analyte components of a sample, will cause the refractive index, and hence θ_{SPmax}, to change. The basis of the assay in this embodiment, therefore, is determining qualitatively or quantitatively a change in θ_{SPmax}, which indicates a change in refractive index, which in turn is indicative of the presence of analyte (impurity in water, in the present case).

FIG. 2 is a schematic graph illustrating how reflectance in a Kretschmann SPR module varies with incident angle, and showing the characteristic dip in reflected intensity when θₗ=θ_{SPmax}. The solid line shows the situation when analyte is unbound to a binding molecule immobilised to the surface, and the broken line shows how the response shifts when analyte is bound to the binding molecule.

Other alternative practical implementations include using focused light beams to shine light simultaneously over a range of incident angles onto the surface, measuring optical phase changes associated with SPR and use of broadband wavelength sources to excite and observe SPR as a function of optical frequency rather than incident angle. Either way, a suitable characteristic of the incident light which corresponds to the maximum surface plasmon excitation is determined.

By means such as described above, the surface is monitored for a change in the relevant property (refractive index in the case of SPR). In a simple embodiment of the invention, a read-out may be provided indicative of the qualitative or quantitative presence or absence of impurity. More complex embodiments will be outlined below, when the invention is described from the point of view of an apparatus.

Although direct affinity sensors have been the subject of extensive study for almost 20 years—an early SPR sensor paper is: “Surface-plasmon resonance for gas-detection and biosensing”, Liedberg, B., Nylander, C. & Lundstrom, I., Sensors and Actuators 4 (1983) 299-304—little commercial exploitation has occurred. The major reason behind this observation is the inability of most biological or chemical coatings used in direct affinity sensors to be truly specific to a complementary analyte. For example, real samples that are required to be analysed are complex, such as blood, serum, foodstuffs, soil, sewage effluent and river water, with many components other than the analytes present within the samples and that will often bind to the biological or chemical coating or other components of the sensor that are interrogated by the transducer. This is often termed non-specific binding (“A direct surface plasmon-polariton immunosensor: Preliminary investigation of the non-specific adsorption of serum components to the sensor interface”, Cullen, D. C. & Lowe, C. R., Sensors and Actuators B 1 576-579 (1990)) and results from sample components binding to the sensor interface via processes including hydrophobic, electrostatic or van der Waals interactions and combinations of such interactions. The consequence of this effect is that, although under controlled conditions such as with laboratory prepared samples low limits of detection of analytes are possible, with real samples the non-specific binding of sample components, many of which are at higher concentrations than the analyte to be detected, produce a transducer response greater than that due to the analyte; such non-specific binding raises the lower limit of detection of the direct affinity sensor. This effect normally renders the system unusable for the desired analysis. This situation is reflected in the lack of commercially successful direct affinity sensors for analysis. The major exception to this, is the exploitation of direct affinity sensors that has occurred in the bio-sciences research and development market where controlled samples are often used. (A publication where a direct piezoelectric biosensor involving an immobilised lipopolysaccharide has been used to detect lipopolysaccharide binding peptides is: “Detection of lipopolysaccharide binding peptides by the use of a lipopolysaccharide-coated piezoelectric crystal biosensor”, Chang, H. C., Yang, C. C. & Yeh, T. M., Analytica Chimica Acta 340 49-54 (1997).) In addition, the use of direct affinity systems with multi-step analytical procedures such as washing steps to remove the non-specifically bound sample components from the chemical or biological coatings are employed though these procedures add additional steps to any analyses and dictate that direct, real-time measurement of the analyte is not possible (see, for example, Fontana E., Pantell, R. H. & Strober “Surface plasmon immunoassay” Applied Optics 29(31) 4694-4704 (1990)). In summary, direct affinity sensors have not found commercial use in the analyses of “real” samples outside the controlled world of the laboratory because of their inability to discriminate the nonspecific binding of sample components to the biological or chemical coatings from the specific interactions with the desired analyte(s) at low concentrations. Hence, direct affinity sensors have been unable to operate with lower detection limits suitable for analysis of analytes at low (typically less than μM) concentrations.

Other embodiments of the invention could include other optical evanescent wave-based systems such as the resonant mirror, grating couplers and optical interferometer devices. For example, the resonant mirror (“Detection and quantification of biomolecular interactions with optical biosensors” Yeung, D., Gill, A., Maule, C. H., et al., Trac-Trends in Analytical Chemistry 14 49-56 (1995)), enables the refractive index at the surface of the optical transducer device to be determined. Thus coating of the transducer surface with an appropriate affinity coating would enable complementary analytes to be measured. A resonant mirror transducer consists of a series of thin dielectric layers of various refractive index that, similar to SPR, can be illuminated in conjunction with a suitable prism with light and the interaction of light with the device measured as a function of incident angle. In more detail, light certain incident angles will resonantly excite guided light in the dielectric layers and which are dependent upon the refractive index at the surface of the device. The optical phase change that occur upon resonance is detected by optical interference measurements at each incident angle. Grating coupler transducers again determine refractive index changes at surfaces, typically by monitoring light transmitted through or reflected off the transducer at varying angles of incidence and can thus also be used, coating with suitable affinity coatings, to detect appropriate analytes. Optical interferometer devices, for example a Mach-Zehnder interferometer typically consist of an stripe optical waveguide on the surface of a planar support that splits into two waveguides (waveguide arms), one of which is allowed to interact with a sample, the other is commonly not exposed to the sample. Variations in refractive index at the surface of the optical waveguide arm exposed to the sample influences via the evanescent wave present at the surface, the optical phase of the light in the waveguide arm. Thus, when the two optical waveguide arms are recombined, an optical phase difference exists between the two guided light beams and optical interference occurs modulating the intensity of the combined light. Thus the variation in intensity can be related to the refractive index at the surface of the transducer and therefore with a suitable affinity coating, can be used to detect suitable analytes. A review of these and other relevant optical biosensors is given in “Optical biosensors” Ramsden J. J., Journal of Molecular Recognition, 10 109-120 (1997).

Further embodiments of the invention could include non-optical based transducer systems such as those based upon piezo-electric and surface acoustic wave devices and direct electrochemical devices such as those involving interfacial impedance changes. For example, piezo-electric and surface acoustic wave devices typically involve the acoustic excitation of the devices, i.e. the physical oscillation or vibration of typically whole devices in piezo-electric crystal devices and surface physical oscillation or vibrations in the case of surface acoustic wave devices. The frequencies of the vibrations are typically megahertz or greater. The frequencies at which vibrations can be sustained are sensitive to the physical properties of the devices including their mass. Thus if the devices are coated with an affinity coating and this binds a complementary analyte, a small mass changes occurs caused by the mass of the bound analyte. The magnitude of the change is commonly detectable as a change in the frequencies at which the devices are vibrating. As an example, a piezo-electric sensor has been constructed to measure the binding of lipopolysaccharide binding peptides to lipopolysaccharide immobilised to the surface of a piezo-electric crystal sensor (“Detection of lipopolysaccharide binding peptides by the use of a lipopolysaccharide-coated piezoelectric crystal biosensor”, Chang, H. C., Yang, C. C. & Yeh, T. M., Analytica Chimica Acta, 340 49-54(1997)).

As previously noted, the production and use of high purity water are part of many industries, with medical, pharmaceutical and electronics industries being of major importance. There is a need to measure organic contaminants such as pyrogens, including lipopolysaccharides and other endotoxins, in high purity water, both continuously and in discrete samples. Current analysis methods do not allow simple continuous measurement of contamination. The concept of direct affinity sensors offers a solution to this problem but as described previously the practical reality is that the non-specific interactions of sample components within real samples would be expected to exclude their use to detect low concentrations of contaminants. High purity water can be viewed as an unusual real sample as it contains few other components apart from the impurity or impurities that are required to be measured. A previously overlooked consequence of this observation is that a direct affinity sensor should be applicable to the measurement of low concentrations of contaminants in high purity water as lack of other sample components eliminates the non-specific interaction problem.

In this invention, “high purity water” may be defined as water which has been treated by any one, or a combination, of the following:

distillation;

reverse osmosis;

ultra-filtration;

de-ionisation (for example on an ion exchange gel).

In particular, high purity water may have been treated by at least one of the above steps and additionally by any one, or a combination, of the following:

sterilisation;

activated carbon treatment (e.g. filtration).

High purity water therefore includes water which either meets, or is intended or is being prepared to meet, at least one of various given purity standards in the relevant industries (including medicine, pharmacy and electronics). Such purity standards include, for medicine and pharmacy:

Purified water, British Pharmacopœia (e.g. BP 1980 and subsequent addenda);

Water for injections, British Pharmacopœia;

Aqua purificata, European Pharmacopœia (e.g. EP 1980, 2^{nd} Edit. Part I and 2^{nd} Edit Part II—5, 1983);

Aqua ad injectabilia, European Pharmacopœia;

Water for injection, United States Pharmacopœia (e.g. USP XX, 1980 and subsequent supplements and addenda);

Bacteriostatic water for injection, United States Pharmacopœia

Sterile water for injection, United States Pharmacopœia;

Sterile water for irrigation, United States Pharmacopœia; and

Purified water, United States Pharmacopœia;

and equivalent standards from later versions of these pharmacopœiæ and those of other territories.

The United States Pharmacopœia (USP) specifies a limit of 0.25 Endotoxin Units per ml (EU/ml) for water to be accepted as water for injection. The USP authorities supply a standard preparation of purified E. coli endotoxin for calibrating the LAL test; it comprises 10,000 EU, which may equate to roughly 4 μg purified endotoxin, which implies that the concentration of endotoxin should not exceed about 100 pg/ml.

For the electronics industry, where high purity water is sometimes referred to as ultra-pure water, purity standards include:

“Grade 1” water (“chemically and biologically pure water”) as defined by Lorch (Lorch, “Water quality classification” in “Handbook of Water Purification”, loc. cit.);

18 MΩ water, i.e. water having a resistivity of at least 18 MΩ at 25° C.; and

>99.999% pure water;

and equivalent and better standards.

In the present invention, a surface is adapted, for example by being modified with a suitable biological or chemical coating, to discriminate and interact by binding (for example physically) to a complementary analyte in a sample. For direct affinity sensors, the biological or chemical coating (which may be termed the “affinity coating”) should be chosen to offer the required degree of specificity or selectivity and the required strength of interaction or affinity. The latter point requires a level of affinity such that for a given concentration of affinity sites in the biological or chemical coating and for a desired concentration of analyte to be detected, sufficient occupancy of the affinity sites occurs to be readily measured by the transducer. The affinity coating specificity or selectivity can be varied by changing the components of the affinity coating. For example, monoclonal antibodies can be chosen that show high specificity for an organic contaminant such as lipopolysaccharide from a given microbial species by selecting antibodies against the variable O-polysaccharide region of lipopolysaccharide from the given species or selecting antibodies showing broad specificity for differing lipopolysaccharides by selecting antibodies against the lipid A region of lipopolysaccharide that is common across many bacterial species. Alternatively or additionally, multi-component coatings may be used.

For the detection of contaminants in high purity water, especially bio-organic contaminants such as pyrogens, endotoxins, lipopolysaccharides, etc., a range of possible chemical and biological affinity coatings can be used.

For the detection of endotoxins, the following is a selection of the more common affinity coatings that can be envisaged:

Antibodies, as previously mentioned, including polyclonal, monoclonal and fragments such as Fab and Fab₂ and recombinant and otherwise engineered antibodies including Fv fragments and single chain Fv fragments;

Naturally occurring peptides such as mellitin from bee venom and the decapeptide antibiotic polymyxin B that interact with endotoxins via amphiphilic and ionic interactions;

Artificial receptors such as combinatorially-generated peptides or peptides generated from known endotoxin binding proteins (see, for example, “Synthetic peptides that mimic the binding-site of horseshoe-crab antilipopolysaccharide factor”, Kloczewiak, M., Black, K. M., Loiselle, P., et al., Journal of Infectious Diseases 170 1490-1497 (1994) and other combinatorially-generated receptors based upon nucleic acids or other biologically or non-biological derived components and molecular-imprinted polymers;

Components of the clotting system from the horseshoe crabs such as Limulus polyphemus and Carcinoscorpius rotundicauda that are sensitive to the presence of endotoxins and commonly used in Limulus Amoebocyte Lysate (LAL) assays. For example, the Factor C protein component that binds endotoxin (see, for example, “Expression of full length and deletion homologues of Carcinoscorpius rotundicauda Factor C in Saccharomyces cerevisiae: immunoreactivity and endotoxin binding”, Ding, J. L., Chai, C., Pui, A. W. M. & Ho, B. Journal of Endotoxin Research 4 33-43 (1997));

Endotoxin binding proteins, and fragments thereof, isolated from eukaryotic and prokaryotic sources such as the CAP18 protein isolated from rabbit granulocytes or other mammalian sources (“The solution structure of the active domain of CAP18—a lipopolysaccharide-binding protein from rabbit leukocytes”, Chen C. P., Brock R., Luh F., et al., FEBS Letters 370 46-52 (1995));

Positively charged ion-exchange materials such as polylysine and polyhistidine (available, for example, from Sigma Aldrich Co. Ltd., Poole, Dorset, UK) that interact ionically with the negatively charged lipopolysaccharide. These examples would be considered to be of broad specificity.

It can be envisaged that if the broad selectivity affinity systems also bind other contaminants present within high purity water samples and thus generates a detectable signal from the sensor, this could be advantageously used in situations where an indicator or alarm of general contamination as opposed to a specific indicator of endotoxin or other specific contamination is required. Affinity coatings especially chosen to bind a broad range of organic and other contaminants can be envisaged such as a hydrophobic coating, e.g. a spin-coated polystyrene film, or general ion-exchange coatings such as polylysine and polyhistidine.

An affinity coating needs to be immobilised or attached within the sensing range of the transducer utilised, generally directly or indirectly on the surface of the transducer, so that sample can be presented to the sensor without the affinity coating being removed from the locality of the transducer. The simplest option is to attach an appropriate affinity component by simple physical adsorption from a suitable solvent, with the result illustrated in FIG. 3a. Commonly this would be a protein-based affinity system physically adsorbed, for example from an aqueous solution. Other preferred options include chemisorption and the covalent attachment of the affinity systems to the surface of a transducer (FIG. 3b) that usually results in an increased stability compared to physical adsorption. For example, a silver SPR surface can be activated via an organofunctional silane or an organofunctional alkane thiol that introduces organic groups to the surface such as amine, carboxyl or glycidoxyl groups that can be use to covalently attach affinity system such as proteins via linker chemistries such as carbodiimide chemistries. The use of polymer modified transducer surfaces, as illustrated in FIG. 3c, is also a preferred option; for example, this option may involve the covalent immobilisation of a polymer such as carboxymethyl dextran to an activated transducer surface thereby enabling the subsequent covalent immobilisation of an affinity system to the carboxyl groups of the carboxymethyl dextran. This approach can produce a thin, three dimensional film on the surface increasing the amount of affinity system present per unit are of the transducer thereby increasing the sensitivity of the final sensor.

In summary, an appropriate immobilisation method is used that enables a suitable amount of affinity system to be stably maintained within close proximity to the transducer surface and that preferably maximises that amount of the immobilised affinity system that is functionally active.

Other parameters that should be considered in the implementation of the invention will be well within the competence of those skilled in the art. They include the control of temperature, as variation in temperature can (i) for optical evanescent wave sensors, affect the refractive index of materials used in construction and use of the sensors thus generating a change in sensor output and (ii) change the affinity constants of the affinity systems used and hence the sensor output signal corresponding to a given concentration of analyte.

According to a second aspect of the invention, there is provided an apparatus for analysing high purity water for the presence of impurity, the apparatus comprising a surface which in use is in contact with the water, wherein the surface has an affinity for a potential impurity in the water and has a property which changes on binding of the impurity to the surface, and means for monitoring the surface for a change in the property.

The surface will usually in practice define at least part of a wall of an analysis cell or chamber, but in principle the apparatus may be developed as a probe or other configuration in which no cell or chamber is present.

Preferred implementations of the invention can be divided into those implementations that are integrated into a high purity water system, i.e. on-line (which term includes being located at the effluent point, which is to say the point of production of the high purity water), and those that are separate and not integrated into a high purity water system, i.e. off-line, with examples including hand-held or bench-top sensor formats. High purity water systems include water purification plant and water delivery/use plant or systems.

A specific implementation of the invention could be a sensor to measure on-line the levels of endotoxins in a high purity water system. The sensor could rely on the phenomena of surface plasmon resonance and consist of an equilateral prism coated on one face, via vacuum evaporation, with a thin film of gold with the film thickness optimised for surface plasmon resonance, typically 50 nanometers. Suitable prisms have been found to include those supplied by Comar Ltd., Cambridge, UK and are made from SF16 optical glass and measure 10 millimeters along each edge. Alternatively, the gold film may be coated onto a glass slide and this optically coupled to a glass prism via a refractive index matching fluid thereby simplifying the replacement of the sensing surface when required. The gold film may have immobilised to its surface a suitable recognition layer such as the peptide mellitin immobilised covalently using an organofunctional alkoxyl silane such as gamma aminopropyltriethoxy silane. A simple arrangement of a laser diode module operating, for example, at a wavelength of 670 nanometers, together with optical lenses will enable the optical beam from the laser to be focused to a point on the internal face of the prism coated with gold and with the focused, converging beam containing simultaneously a range of incident angles directing upon the surface. The beam reflected off the internal prism face will diverge and the light intensity distribution across the beam, and hence incident angle, can be measured by a linear photodiode array. The light distribution across the beam will exhibit a sharp decrease in intensity at a particular point corresponding to the excitation of surface plasmons and that will move depending on changes in the refractive index at the surface of the gold films and that will be proportional to the amount of analyte bound to the sensor surface.

The sensor described could be operated in a number of differing modes. The sensor may have sample continuously flowing past the sensing surface. For example, high purity water flowing through a pipe may be continuously withdrawn by a suitable sampling system and caused to flow past the sensor, with the water sample eventually going to waste. The sensor may even be placed directly into the pipe though issues of access to the sensor for maintenance or replacement and possible contamination of the high purity water system may make this a less favoured option.

As the sample passes over the sensor surface with the immobilised affinity coating, the analyte, e.g. endotoxin, will bind to the surface at a rate dependent on the concentration of the analyte present in the sample. If the affinity of the interaction is high, the sensor signal will increase as further analyte binds, i.e. little bound analyte will dissociate from the sensor if the concentration in the sample is reduced. Therefore at a given instance, the rate of change of the sensor output will be a function of the concentration of the analyte and the magnitude of the signal will be a function of the total amount of endotoxin that the sensor has been exposed to in its lifetime, i.e. the apparatus will function as a dose meter. Such a sensor could be used as an alarm set to respond to either a pre-set instant level of analyte concentration or to a pre-set level of dose of analyte; the alarm could call a plant operator's attention to the event, and/or result automatically in some predetermined response, such as a change of process conditions or causing sub-standard water to be wasted or recycled. The operational lifetime of such a sensor will be dependent on the concentration of the analyte present and would typically be set to the time taken for the affinity coating to reach a given fraction of its maximum capacity. At this point the sensing surface may be replaced with another sensor, e.g. a gold-coated prism or slide with the affinity coating, and the removed sensor recycled or disposed. Alternatively, the affinity coating could be regenerated, for example, by stopping temporarily the sample flow and replacing the sample flow with a flow of a regeneration solution such as a low pH buffer solution that would destabilise the analyte/affinity coating interaction allowing the analyte to diffuse away from the sensor surface. The sample flow would then be re-established. This approach would be especially advantageous if the operation lifetime of the sensor was short, due possibly to a high concentration of analyte. In addition to a homogeneous sensing surface coated with a single affinity coating, implementations can be envisaged that contain a number of different affinity coatings in a single sensor. The coatings could be immobilised to discrete areas on the gold and the intensity of the reflected light measured from each area giving a number of SPR responses equivalent to the number of different areas/affinity coatings. For example, in the simplest case, mellitin could be immobilised to one area and the remaining area of the gold film left unmodified so as to act as a reference signal to correct for variation in background signals. Alternatively a number of different affinity coatings could be discretely immobilised enabling the differing selectivities of individual affinity systems to be pooled, hence reducing bias towards a given sub-set of endotoxin species.

In addition to on-line sampling, there is also a requirement for rapid analysis of organic contamination, for example by endotoxins, of high purity water off-line, e.g. in discrete samples taken from a high purity water system or to test samples taken from stored or packaged high purity water. The present invention will also be appropriate to these situations. One implementation would be the system described for on-line analysis, adapted to handle discrete samples. For example, a liquid handling system comprised of peristaltic or syringe pumps together with appropriate valving would be used to draw material from a discrete sample and to cause it to flow past the sensor. Alternatively, the sample could be directly placed, for example by pipetting, in contact with the sensor. Since for discrete samples continuous monitoring is not required, a favoured implementation would utilise a regeneration step after each analysis as previously described for the on-line system.

The packaging of an off-line sensor could be envisage in a bench-top format either with or without automated sample handling or in a portable or hand-held meter for direct application of the sample in a probe or “dip-stick” fashion. The portable or hand-held meter formats would be expected to have a single use, disposable sensor component thereby eliminating the requirement for regeneration of the affinity coating.

According to a third aspect of the invention, there is provided a direct affinity sensor for pyrogen.

According to a fourth aspect of the invention, there is provided a surface plasmon resonance device comprising a surface capable of exhibiting surface plasmon resonance coated with an affinity coating for pyrogen.

Such a device may be a grating, an optical fibre or, preferably, a prism, or it may be a slide or like component which is adapted to be optically coupled to a grating, optical fibre or, preferably, prism.

According to a fifth aspect of the invention, there is provided a high purity water system comprising an apparatus as described above and/or a direct affinity sensor as described above and/or a device as described above.

According to a sixth aspect of the invention, there is provided water, at least a sample of which has been analysed by a method as described above and/or by means of an apparatus as described above and/or a direct affinity sensor as described above and/or a device as described above.

Preferred features of each aspect of the invention are as for each other aspect, mutatis mutandis.

The invention will now be illustrated by the following Examples.

### EXAMPLE 1

A demonstration of the direct affinity sensor concept for the detection of organic contamination by lipopolysaccharide (LPS) has been achieved using a laboratory-based surface plasmon resonance system with silver-coated prisms to which the affinity coating mellitin is immobilised by physical adsorption. Exposure to high purity water samples doped with LPS resulted in a measurable signal from the surface plasmon resonance system.

Materials and Methods

A specially built SPR system is shown generally in FIG. 4. The system contains a light source 21 comprising a laser diode module light source (RS Components, Northants., UK) producing a collimated, light beam with a wavelength of 670 nm. The laser light source has includes a modulator unit to allow an AC signal to modulate the output, and in this example are set to modulate the output at 150 Hz. The emitted laser beam passes through a dichroic sheet polariser 23 (Melles Griot, Cambridge, UK) to ensure a plane polarised beam and then through an optical half-wave plate 25 (Melles Griot, Cambridge, UK) housed in a rotatable mount to enable manual rotation of the plane of polarisation, for a purpose to be made clear in due course. The beam also passes through a neutral density filter 27 (Melles Griot, Cambridge, UK), slightly misaligned from the orthogonal to avoid reflection, to reduce the beam's intensity; and then through a first iris 29 (Melles Griot, Cambridge, UK) to reduce the beam to a small spot of about 1 mm in cross sectional diameter.

The beam then enters a beam splitter 31. A reference beam is split off at right angles, passes through a neutral density filter 33 and enters a reference photodiode detector 35 to monitor the intensity of the laser beam for reference purposes. The main beam, somewhat attenuated by the beam splitter 31, passes through a second iris 37, to help with beam collimation, and into a surface plasmon resonance (SPR) device shown generally by reference numeral 39 (see also FIG. 5).

The SPR device 39 comprises a 1 cm² faced equilateral prism 41 made of SF16 optical crown glass (refractive index=1.69 at 670 nm) (Comar Ltd., Cambs., UK) with one surface 43 coated with a silver film of thickness 50 nm using an Edwards E306A vacuum evaporation unit (Edwards Vacuum Products, Crawley, UK).

The light beam is directed onto the metalised prism 41 held by means of a first clamp 45 (FIG. 5) onto a thin-layer flow-cell 47 that enables liquid sample to flow in through an inlet 49, past the sensing surface, i.e. the metalised prism surface 43, and out through an outlet 51. The flow-cell was designed by the inventors and manufactured by a local engineering firm (Kinns Engineering, Bucks., UK). Held by a second clamp 53 against a PERSPEX™ polymethylmethacrylate block 55, from which it is spaced apart by a VITON™ hexafluoropropylene/vinylidene fluoride copolymer gasket (not shown), the thin-layer flow-cell 47 has a thickness of 500 μm and a volume of 90 μl. Liquids are pumped through the flow-cell using a peristaltic pump (not shown) (Anachem Ltd., Beds., UK).

The flow-cell is mounted on a computer controlled, motorised first rotation stage 57 (Speirs Robertson, Beds., UK) with a step resolution of 0.01 degree to enable the prism 41 and flow-cell 47 to be rotated and hence the incident angle of the laser beam onto the internal metalised face 43 of the prism 41 to be varied. The first rotation stage 57 is mounted above an identical second rotation stage 59 on a common rotation axis 61 that also allow independent rotation of the stages 57 and 59. To the second rotation stage 59 a silicon photodiode detector 63 (RS Components Ltd., Northants., UK) is mounted via an arm arrangement 65. Thus as the prism 41 is rotated, the intensity of the reflected laser beam could be measured by rotating the second rotation stage 59 and hence the detector 63 to track the moving reflected laser beam.

The rotation stages 57 and 59 are controlled by a personal computer (Viglen Computer, Middlesex, UK) (not shown) using a GPIB interface (National Instruments Ltd., Berks., UK) and the voltage output from the silicon photodiode detector 61 recorded via an analogue-to-digital converter card (National Instruments Ltd., Berks., UK) mounted in the personal computer. Dedicated control and data acquisition software was written using the LABVIEW™ software package (National Instruments Ltd., Berks., UK).

Mellitin and lipopolysaccharide (LPS) (E. coli serotype 055:B5) were purchased from Sigma Aldrich Co. Ltd. (Dorset, UK) and high purity water (AnalaR grade) obtained from BDH Ltd. (Dorset, UK).

Typical Experiment Protocol

Obtaining SPR data consists of recording firstly the reflectivity, for TM polarised light, of a silver-coated prism as a function of incident angle over a range of typically 10 degrees centred on an incident angle impinging on the internal metalised face 43 of the prism 41 of, typically, 55°. (Transverse electric (TM) means that the magnetic field vector of a light beam is transverse to the plane of incident and reflection of the light beam incident upon an interface; transverse electric (TE) means that the electric field vector is so transverse.) These values are appropriate when using water-based samples. This is immediately followed by a second recording of the reflectivity under identical conditions except for the use of TE polarised light obtained by rotating the optical half-wave plate 25 in the SPR measurement system. Since the SPR only occurs for the described system with TM polarised light, the calculation and presentation of the ratio of the TM verses TE reflectivity generates a normalised dataset independent of the absolute magnitude of the reflected light.

Also, the fact that the output of the laser light source 21 is modulated to 150 Hz means that the software can distinguish between light reaching the detector from the laser light source 21 and light from other sources (such as mains voltage lighting, which is modulated at 50 Hz, and daylight, which is unmodulated). The reference photodiode detector 35 provides the software with the necessary data for this purpose. It is therefore unnecessary for the apparatus to operate in a light-tight box, providing of course that the level of ambient light does not cause the detector 61 to become saturated. In a production model of an apparatus in accordance with the invention, it may well be more convenient and less costly to house the apparatus in light-tight conditions, thereby to enable the design to be simplified in this respect.

FIG. 6 shows example reflectivity curves showing the excitation of surface plasmons on a silver-coated prism in the presence of high purity water after exposure to a solution containing 100 μg/ml of mellitin followed by washing with water (curve labelled “Mellitin”) and after subsequent exposure of the mellitin coated prism to a high purity water sample doped with a high concentration (10⁵ EU/ml) of LPS (curve labelled “LPS”).

The typical shape of the SPR response seen in FIG. 6 enables an angle value to be determined corresponding to the angle at which the minimum reflectivity occurs and which coincides with the angle for optimum surface plasmon excitation. As refractive index changes occur at the surface, for example due to the physical adsorption of mellitin on the metalised face 43 of the prism 41 (FIG. 4) or the subsequent binding of LPS to the physically adsorbed mellitin, the angle for optimum surface plasmon excitation changes and the relative change can be recorded as the angle shift in position of the SPR minimum.

The sequence of reflectivity versus incident angle scans (SPR scans) for a typical experiment to demonstrate the detection of LPS follows:

1. Air SPR scan: to ensure a suitable SPR response is obtained

2. Water SPR scan: to provide a base line or reference for subsequent interactions of mellitin and LPS

3. Buffer SPR scan: to provide a baseline for the mellitin immobilisation step as immobilisation by physical adsorption occurs from a buffered solution (buffer=sodium phosphate pH 7.0, 10 mM)

4. Mellitin deposition SPR scan: in the presence of a 100 μg/ml solution of mellitin in buffer after 30 minute incubation.

5. Buffer wash SPR scan: to wash the SPR surface after exposure to the mellitin solution with the difference between scans 3 and 5 representing the amount of mellitin immobilised

6. Water wash SPR scan: the SPR surface is washed with water to provide a basis for analysis with LPS deposition.

7. LPS analysis SPR scan: in presence of an appropriate concentration of LPS in high purity water with the difference between scans 6 and 7 representing the amount of LPS bound to the surface which can be related to the concentration of LPS in the sample

In the current experiments, after the above sequence of events, the silver films are removed from the prisms and re-coated with a fresh film of silver for further study.

Results

Initial experiments have focused on demonstrating the principle of direct affinity sensing of LPS. FIG. 6 shows a typical set of SPR scans for the physical adsorption of mellitin and the subsequent interaction of LPS. FIG. 7 summarises a series of experiments where the concentration of LPS in high purity water was varied between 10⁵ and 10² endotoxin units per milliliter (EU/ml). The resultant shifts in position of the SPR minima are presented showing for the current system the apparent saturation of the SPR shift at high concentrations of LPS, i.e. greater than 10⁴ EU/ml, and below this level that the SPR shift is related to the concentration of LPS present in the sample.

Upon simple improvements to the experimental protocol, consisting of improved washing of the experimental flow system and improved handling of the silver-coated SPR devices prior to mellitin immobilisation to limit surface contamination, improvements in sensitivity and lower limits of detection enable a range of endotoxin concentrations between 0 and 40 endotoxin units per milliliter (EU/ml) to be measured. FIG. 8 summarises a series of such SPR experiments using the refined experimental protocols and confidently discriminates a sample with an endotoxin level of 10 EU/ml from a water control (0 EU/ml) consisting of water certified with <0.001 EU/ml. Also, detection of endotoxin at concentrations of 4 and 1 EU/ml is seen though with less confidence.

Conclusion

The experiments described demonstrate the principle of endotoxin detection in purified water samples using a sensor, in this example one based upon surface plasmon resonance, coated with a suitable recognition layer: mellitin immobilised by physical adsorption. This simple example demonstrates detection down to 10 or 1 EU/ml.

### EXAMPLE 2

A second embodiment of an apparatus is shown in FIG. 9, which is arranged in a manner similar to FIG. 4. The system contains a light source 71 comprising a laser diode module light source (RS Components, Northants., UK) producing a collimated, light beam with a wavelength of 670 nm. The emitted laser beam passes through an optical assembly 73 comprising a polariser and a half wave plate, which correspond to the polariser 23 and half wave plate 25 of the apparatus shown in FIG. 4. The beam then passes through a first lens 75, which causes the beam to diverge, and a second lens 77, by which stage the beam is expanded and collimated. A third lens 79 is cylindrical and focuses the expanded, collimated beam in one dimension through a prism 81 down to a vertically aligned stripe on a silver-coated surface 83 of the prism 81 to which mellitin is bound. As in the apparatus shown in FIG. 4, the prism 81 is held onto a thin-layer flow-cell 87 that enables liquid sample to flow in through an inlet 89, past the sensing surface, i.e. the metalised prism surface 83, and out through an outlet 91. The flow cell 87 is held against a PERSPEX™ polymethylmethacrylate block 95, from which it is spaced apart by a VITON™ hexafluoropropylene/vinylidene fluoride copolymer gasket (not shown) and is sized identically to the flow cell of FIG. 4. Again, liquids are pumped through the flow-cell using a peristaltic pump (not shown).

The laser beam is reflected off the metalised prism surface 83 and expands as it emerges from the prism 81 towards a fixed detector assembly 103 comprising an array 105 of 256 photodiodes mounted on a stage 107. Data from the photodiode array 105 is fed into a personal computer.

The operation of the apparatus of FIG. 9 is similar to that of the apparatus of FIG. 4, with the primary exception that the fixed detector assembly simultaneously captures the intensity of reflected light from the metalised prism surface 83 at a variety of angles; each pixel corresponds to a particular angle. Operation is therefore quicker, in that the whole of a response curve such as that shown in FIG. 6 can in effect be read instantly, and the absence of moving parts in the detector assembly is likely to prove a more robust construction. Another difference from the FIG. 4 apparatus is that, since no reference beam is split off to enable the software to distinguish between modulated light originating in the laser and light from elsewhere, the apparatus needs to be housed in a light-tight box.

A possible integration of the apparatus of FIG. 9 into a high purity water treatment plant is shown in FIG. 10. The additional apparatus consist of a liquid pump such as a peristaltic pump 111 to draw a water sample continuously from a “bleed-off” 113 from a high purity water treatment plant 115 via a fluid switching valve 117 to the SPR flow cell 87, from which the water goes to waste. (The associated laser and other optical components are shown in simplified form for clarity.) The fluid switching valve 117 may be switched to an alternative position in which wash and regeneration solution is drawn from a reservoir 119 periodically to regenerate the surface 83 of the flow cell 87. The orchestration of the fluid flows is controlled via the pump 111 and the fluid switching valve 117 by an electronic control unit 121 that is also used to control and record data from the detector assembly 103, as represented by the schematic representation of the SPR absorption curve 123, and display the resultant level of endotoxin present in the water sample.

1. A method for analysing high purity water for the presence of impurity, the method comprising causing water under analysis to come into contact with a surface having an affinity for a potential impurity in the water, and wherein the surface has a property which changes on binding of the impurity to the surface, and monitoring the surface for a change in the property.

2. A method as claimed in claim 1, wherein the surface is modified with a suitable biological or chemical coating to bind to the impurity in the water.

3. A method as claimed in claim 2, wherein the coating is a biological coating which comprises a specific binding molecule.

4. A method as claimed in claim 2, wherein the coating is a chemical coating which comprises an ion-exchange material.

5. A method as claimed in any one of claims 1 to 4, wherein the property which changes on binding of the impurity to the surface is an optical property.

6. A method as claimed in claim 5, wherein the refractive index of the surface changes on binding of an impurity to the surface and wherein the change in refractive index is monitored by surface plasmon resonance (SPR).

7. A method as claimed in claim 6, wherein the surface is a metal-coated prism face, and wherein the refractive index is monitored by shining appropriate light through a non-metal-coated face of the prism so as to be totally internally reflected off the internal metal-coated face of the prism and determining a suitable characteristic of the light which corresponds to minimum internal reflectance and hence maximum surface plasmon excitation.

8. A method as claimed in claim 7, wherein the light is monochromatic and the characteristic of the light which corresponds to minimum internal reflectance is the incident angle.

9. A method as claimed in claim 7, wherein the light is broadband and the characteristic of the light which corresponds to minimum internal reflectance is frequency.

10. A method as claimed in any one of claims 1 to 9, wherein the impurity is of biological origin.

11. A method as claimed in claim 10, wherein the impurity comprises pyrogen.

12. A method as claimed in claim 10, wherein the impurity comprises endotoxin.

13. A method as claimed in claim 10, wherein the impurity comprises lipopolysaccharide.

14. A method as claimed in any one of claims 1 to 13, wherein the high purity water is water which either meets, or is intended or is being prepared to meet, at least one of the following standards:
Purified water, British Pharmacopœia (e.g. BP 1980 and subsequent addenda);
Water for injections, British Pharmacopœia;
Aqua purificata, European Pharmacopœia (e.g. EP 1980, 2^{nd} Edit. Part I and 2^{nd} Edit Part II—5, 1983);
Aqua ad injectabilia, European Pharmacopœia;
Water for injection, United States Pharmacopœia (e.g. USP XX, 1980 and subsequent supplements and addenda);
Bacteriostatic water for injection, United States Pharmacopœia
Sterile water for injection, United States Pharmacopœia;
Sterile water for irrigation, United States Pharmacopœia; and
Purified water, United States Pharmacopœia;
and equivalent standards from later versions of these pharmacopoeia and those of other territories.

15. A method as claimed in any one of claims 1 to 13, wherein the high purity water is water which either meets, or is intended or is being prepared to meet, at least one of the following standards:
“Grade 1” water (“chemically and biologically pure water”) as defined by Lorch (Lorch, “Water quality classification” in “Handbook of Water Purification”, loc. cit.);
18 MΩ water, i.e. water having a resistivity of at least 18 MΩ at 25° C.; and
>99.999% pure water;
and equivalent and better standards.

16. A method as claimed in claim 2, wherein the coating comprises one or more of:
Antibodies, including polyclonal, monoclonal and fragments such as Fab and Fab₂ and recombinant and otherwise engineered antibodies including Fv fragments and single chain Fv fragments;
Naturally occurring peptides such as mellitin from bee venom and the decapeptide antibiotic polymyxin B that interact with endotoxins via amphiphilic and ionic interactions;
Artificial receptors such as combinatorially-generated peptides or peptides generated from known endotoxin binding proteins;
Components of the clotting system from the horseshoe crabs such as Limulus polyphemus and Carcinoscorpius rotundicauda that are sensitive to the presence of endotoxins and commonly used in Limulus Amoebocyte Lysate (LAL) assays, for example, the Factor C protein component that binds endotoxin;
Endotoxin binding proteins or fragments thereof isolated from eukaryotic and prokaryotic sources such as the CAP 18 protein isolated from mammalian sources;
Positively charged ion-exchange materials such as polylysine and polyhistidine that interact ionically with the negatively charged lipopolysaccharide.

17. A method as claimed in claim 2, 3, 4 or 16, wherein the coating is physically adsorbed onto the surface.

18. An apparatus for analysing high purity water for the presence of impurity, the apparatus comprising a surface which in use is in contact with the water, wherein the surface has an affinity for a potential impurity in the water and has a property which changes on binding of the impurity to the surface, and means for monitoring the surface for a change in the property.

19. An apparatus as claimed in claim 18, wherein the surface defines at least part of a wall of an analysis cell or chamber.

20. An apparatus as claimed in claim 18 or 19, wherein the surface is modified with a suitable affinity coating to bind to the impurity in the water.

21. An apparatus as claimed in claim 20, wherein the affinity coating is a biological coating which comprises a specific binding molecule.

22. An apparatus as claimed in claim 20, wherein the affinity coating is a chemical coating which comprises an ion-exchange material.

23. An apparatus as claimed in any one of claims 18 to 23, wherein the property which changes on binding of the impurity to the surface is an optical property.

24. An apparatus as claimed in claim 23, wherein the refractive index of the surface changes on binding of an impurity to the surface and wherein the monitoring means monitor the change in refractive index by surface plasmon resonance (SPR).

25. An apparatus as claimed in claim 24, wherein the surface is a metal-coated prism face, and wherein the monitoring means monitor the refractive index by determining a suitable characteristic of appropriate light shone through a non-metal-coated face of the prism so as to be totally internally reflected off the internal metal-coated face of the prism, which characteristic of the light corresponds to minimum internal reflectance and hence maximum surface plasmon excitation.

26. An apparatus as claimed in claim 25, wherein the light is monochromatic and the characteristic of the light which corresponds to minimum internal reflectance is the incident angle.

27. A method as claimed in claim 25, wherein the light is broadband and the characteristic of the light which corresponds to minimum internal reflectance is frequency.

28. An apparatus as claimed in any one of claims 18 to 27, wherein the impurity is of biological origin.

29. An apparatus as claimed in claim 28, wherein the impurity comprises pyrogen.

30. An apparatus as claimed in claim 28, wherein the impurity comprises endotoxin.

31. An apparatus as claimed in claim 28, wherein the impurity comprises lipopolysaccharide.

32. An apparatus as claimed in claim 20, wherein the affinity coating comprises one or more of:
Antibodies, including polyclonal, monoclonal and fragments thereof;
Naturally occurring peptides that interact with endotoxins via amphiphilic and ionic interactions;
Artificial receptors;
Components of the clotting system from the horseshoe crabs such as Limulus polyphemus and Carcinoscorpius rotundicauda that are sensitive to the presence of endotoxins;
Endotoxin binding proteins isolated from eukaryotic and prokaryotic sources, or fragments of such proteins;
Positively charged ion-exchange materials such as polylysine and polyhistidine that interact ionically with the negatively charged lipopolysaccharide.

33. An apparatus as claimed in claim 21, 22, or 23, wherein the affinity coating is physically adsorbed onto the surface.

34. An apparatus as claimed in any one of claims 18 to 33, which is integrated into a high purity water system.

35. An apparatus as claimed in claim 25, wherein the metal coated prism face is formed on a slide which is optically coupled to the prism.

36. A direct affinity sensor for pyrogen.

37. A surface plasmon resonance device comprising a surface capable of exhibiting surface plasmon resonance coated with an affinity coating for pyrogen.

38. A surface plasmon resonance device as claimed in claim 37 which is a prism.

39. A surface plasmon resonance device as claimed in claim 38 which is a slide adapted to be optically coupled to a prism.

40. A high purity water system comprising an apparatus as claimed in any one of claims 18 to 35 and/or a direct affinity sensor as claimed in claim 36 and/or a device as claimed in claim 37, 38 or 39.

41. Water, at least a sample of which has been analysed by a method as claimed in any one of claims 1 to 17 and/or by means of an apparatus as claimed in any one of claims 18 to 35 and/or a direct affinity sensor as claimed in claim 36 and/or a device as claimed in claim 36, 37 or 38.
